(19) United States
(12) Patent Application Publication
(10) Pub. No.: US 2007/0194536 A1
(43) Pub. Date: Aug. 23, 2007

(54) Airtight magnetic seal for bearing casings

(75) Inventor: Paulo Roberto Leite Nobrega, Sao Vicente (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. - PETROBRAS

(21) Appl. No.: 11/585,332

(22) Filed: Oct. 24, 2006

(30) Foreign Application Priority Data
Oct. 31, 2005 (BR) PI 0505173-8

(51) Int. Cl. F16J 15/34

(52) U.S. Cl. 277/378

(57) ABSTRACT

An airtight magnetic seal (1) that uses the repulsive property inherent in magnetic bodies of the same polarity to keep seal components in permanent contact. The seal is provided with a magnetic device capable of hermetically sealing the inside of the bearing casing. In addition it is of a reduced external size. A set of components, such as: head, primary seal, magnets, housing, baffles, and O-rings, arranged in such a way that the peculiar configuration and dispositions of the construction allow the attainment of a total thickness, after mounting, which is thinner than the seals currently in existence.

### FIELD OF THE INVENTION

The present invention refers to an airtight magnetic seal for the bearing casings in pumps. The seal is provided with a magnetic device capable of hermetically sealing the inside of the bearing casing. In addition it contains a baffle of reduced external size on the outside.

### DESCRIPTION OF THE RELATED ART

The oil industry and other diverse processes that with great frequency involve, and make use of various models of centrifugal pumps.

Petroleum, from its extraction on production platforms, to its transportation through various methods, such as oil pipes or tanker ships, and mainly in the refining process itself, in specific industrial parks, needs to be pumped through thousands of meters of pipes, hundreds of systems, which, in the popular jargon, are known as the oil extraction and refining process.

Thus, the most important components and those most subjected to wear in the oil industry, are the pumps, which are used in diverse applications, which come in various models and powers, which require great attention in-their specifications and maintenance.

Due to the fact that they are an indispensable component in any stage of the oil industry, many pumps are used without interruption, stopping only in the event of failures or for scheduled maintenance.

However pumps have ball bearings, inside the bearing casings, that are sensitive to any contaminant from the environment where the pump is running. They also possess a component particularly subject to failure, the seal, which isolates the ball bearings on the inside of bearing casings as well as preventing any trace of lubricant inside the bearing casing from contaminating the environment.

In this sense, there are some models of seals, which for the purpose of being in accordance with standards, try to satisfy to the maximum these conditions of isolation. One of these is the American Petroleum Institute Standard—API 610, 9th ed. (2003), which states:

“5.10.2.7—Bearing cases must be designed to prevent contamination from moisture, dirt and other foreign objects . . . This must be accomplished not by injecting compressed air, but through the use of seals, such as labyrinth or magnetic seals, in the areas where the shaft crosses through the casing”

However, complete fulfillment of this requirement can only be accomplished by using a contact seal, therefore using labyrinth seals, even though they are accepted by the standard, allows steam to enter and condense inside the oil. This option, in practice, generates great losses to the oil industry, especially when all the hours involved in down time is accounted for in the production process, as well as the cost of man-hours in maintenance and repair of the ball bearings in the pumps.

It has been possible to measure these damages due to studies that have demonstrated that the presence of only 0.02% of water in the oil of casings is sufficient to reduce the useful life of the ball bearings up to 48%.

Thus, the greatest concern of the technician responsible for maintenance of the pumps is to make the best choice from the existing models of seals, in order to prevent failures, especially when dealing with 20 centrifugal pumps. Any unscheduled downtime, especially those caused by failures of the mechanical seal in the bearing casings, not only interrupts the process with which that pump is associated, but, invariably, damages many other pump components as well.

Therefore, the better the quality of the isolation provided by the casing seal, the greater the durability of the equipment. And it is in this way that the oil industry's technical designers attempt to surpass the requirements of Standard API 610, 9th ed. (2003), and they conduct their projects so that the seal of the bearing casings (mainly in centrifugal pumps), will be completely air tight.

Currently, there are some models known that attempt to fulfill this condition, for example:

1°) Mechanical airtight seal that uses springs.

The GBS® model developed by the A.W. Chesterton Company is a good example. This type of airtight seal has a good service life expectancy and performance when mounted correctly, however the assembly requires special attention be given to its alignment. It is a seal that occupies little external space, and offers a descending wear curve. However when the required criteria are not observed when aligning the seal, many failures will occur. The seal assembly is difficult due to the high degree of interference presented for the O-ring in the rotary head. The repair of the seal is difficult and offers little protection against direct jets of liquid on the outside surface of the operation.

2°) Magnetic airtight seal, with magnets in the attractive position.

The Magnum-S® model may be mentioned as an example developed by the Isomag Corporation. This type of airtight seal is easy to assemble and occupies little external space. However it offers an upward wear curve, because the greater the wear of the material, the greater the distance between magnets and greater the force of attraction, causing greater wear and a shorter service life expectancy. It is also a seal that cannot be repaired and offers little protection against direct jets of liquid on the outside surface of the operation.

3°) Magnetic airtight seal, with magnets in the repulsive position.

The RMS 700® model may be mentioned as an example developed by the Improseal Corporation. This type of airtight seal needs a great amount of free external area, does not offer any type of external protection, which is totally exposed to the inclemency of the environment. This also is a seal that cannot be repaired. It's characteristic of being exposed to dirt and because it requires a large external mounting area, makes it practically impossible to adapt it to pumps (mainly centrifugal pumps).

In the case of the bearing casing seal models that currently use magnets in the repulsive position specifically; their construction is that of a stationery head.

The head is one of the key elements for maintaining the impermeability of the project, with its function being to support the primary seal, which is pressed against its surface in such a way as to maintain permanent and hermetic contact.

This contact between the head and the primary seal must be preserved from contamination emanating from the environment, such as dust, solid debris, or direct jets of liquids, as it prevents in this way premature eroding between the head and the primary seal, which is already in a permanent state of friction.

The head is fixed upon the sleeve by means of an O-ring and this set of components travels along with the rotation of the shaft.

The primary seal is fixed to the housing by means of an O-ring, behind which are also mounted two collars of magnets in the repulsive position. The magnets in direct contact with the housing and the back of the primary seal travel along with the rotation of the shaft, and promote the compression of the primary seal towards the rotary head.

There is a great advantage to this type of seal created through pressure caused by the repulsive force of magnets: with the passage of time, wear due to friction between the head and the primary seal will cause aberrance between the magnets pressuring the seal against the head. This aberrance will result in a reduction in the repulsive force, and consequently in the friction pressure between the head and the primary seal. This results in less abrasion between these two components and, for this reason, a much greater service life expectancy and preservation of the properties of impermeability. However the seals on bearing casings that use this sealing system, present problems with alignment that can invalidate this advantage.

Seals, such as those mentioned in the 1^{st} example, that use rotary heads may offer several advantages which may be invalidated if not mounted with perfect alignment, therefore, in the event that the alignment is not accomplished, abrasion may be even greater than the other models of seals for bearing casings that use springs or magnets in the attractive position.

Alignment is a requirement that is very difficult to achieve in the bearing casings of models currently in existence, because the head is stationery, and the primary seal is mounted upon a rotary sleeve. In turn, the sleeves are provided with only one O-ring.

This type of construction that places the sleeve on the only O-ring causes a misalignment in the setting of the head on the primary seal, and requires that the repulsive action of the magnets continuously correct, on every turn, the deficiencies of this misalignment.

In models that are currently available on the market, perfect alignment is only obtained by very meticulous installation work and preferably calibrated with a time source dial indicator for centering. It is a task that in addition to requiring its own specialized tools, demands time and must be performed by a skilled technician.

The material currently used on the contact surface of the head presents yet another problem. Generally, stainless steel is used, which is somewhat deficient in its capacity to resist abrasion, and also generates high temperatures.

Therefore, no seal model for bearing casings currently available offers a repair feature for the seal assembly. And due to fact that their most sensitive components are generally susceptible to excessive exposure to inclemency, at the end of their service lives, they are so deteriorated that repair is not feasible.

The three models of airtight seals for bearing casings, in spite of offering advantages, also present disadvantages that may result in premature failures or the need for periodic maintenance.

Considering the fact that each pump needs at least two seals, and that a refinery of average size is using around 1000 pumps, easily proves the problem and the damage caused by the disadvantages present in the current sealing technique used in bearing casings.

This invention endeavors to provide an airtight mechanical seal for bearing casings, using magnets in the repulsive position as the tightening method in the primary seal on the head.

Other purposes that the airtight mechanical seal for bearing casings, the object of this invention, seeks to accomplish are listed below:

a. Guarantee impermeability against oil spills into the environment;

b. Guarantee impermeability against the entrance of contaminants from the environment into the bearing casing;

c. High protection against jets of liquids;

d. Reduce the need for specialized professionals to mount the mechanical seal;

e. Eliminate the need for specialized tools to center the seal;

f. Provide a longer service life than the pump itself to which it will be installed;

g. Facilitate mounting through auto-regulating alignment;

h. Assembly with axial adjustment made with the seal itself;

i. Possibility of repairing the seal and the majority of its components;

j. Rotary head;

k. Very low cost repairs;

l. Secure operation with minimal heat generation;

m. Uses little external space;

n. Possibility of use in pumps, specifically centrifugal pumps.

### SUMMARY OF THE INVENTION

This invention refers to an airtight magnetic seal that uses the repulsive property inherent in magnetic bodies of the same polarity to keep seal components in permanent contact.

The invention includes a set of known components, such as: head, primary seal, magnets, housing, baffle, O-rings, arranged in such a way that the peculiar configuration and dispositions of the construction allow the attainment of a total thickness, after mounting, which is thinner than the seals currently in existence.

In general terms, the assembly is arranged in the following manner: The J sleeve, which reclines in relation to the shaft, has two different sections: one parallel, and the other perpendicular to the shaft. The thick section is positioned in such a way that it is turned towards the inside of the bearing casing and is provided with two different levels forming a hollow area. The internal wall of the sleeve that faces the shaft's surface is provided hollow areas on its ends that accommodate the O-ring seals. The lower level of the perpendicular part of the sleeve accommodates a seal ring.

The head is nested into the hollow area in the sleeve, directly at the lowest level of the sleeve and over the O-ring seal, opposite the highest level.

The primary seal, in the form of an “H”, is mounted on its contact surface juxtaposed towards the surface of the functioning head. Its rear edges form a hollow area with the rear surface where a collar provided with magnetic elements is fitted.

Adjacent and parallel to the collar which is already mounted, another similar collar is provided (but without touching each other), which is set on the inside surface of a “J” shaped housing. The housing fits through an opening in the bearing casing, until a shoulder on its external surface leans against the external surface of the bearing casing.

Finally, for the purpose of giving extra protection, an L-shaped baffle fits at the outside end of the sleeve, overlapping part of the housing's external surface.

### BRIEF DESCRIPTION OF THE DRAWINGS

The invention shall be described in greater detail, together with the related illustrations below (as an example only), which are included with the present report, of which they are an integral part, and in which:

FIG. 1 shows a cross-section view of the airtight magnetic seal joined on a shaft and on a bearing casing,

FIG. 2 shows a cross-section and exploded view along a normal shaft of the airtight magnetic seal.

FIG. 3 shows a simple cross-section view in perspective of the components mounted on the airtight magnetic seal.

FIG. 4 shows an asymmetrical cross-section view in perspective of the components mounted on the airtight magnetic seal.

### DETAILED DESCRIPTION OF THE INVENTION

The present invention refers to an airtight magnetic seal for the bearing casings, developed principally for application in centrifugal pumps.

In addition to fulfilling its main objective of a seal, it is also features great durability and final use conditions, at the end of the pump's service life, that make its restoration and reuse possible.

The airtight magnetic seal objective, in its preferred construction alternative, provides two aligned/adjusted sealing components, under permanent and constant contact during the entire service life of a pump. In this way, impermeability is maintained between the internal and external materials of the bearing casing during the entire service life of the pump.

The airtight magnetic seal is also planned so that the force that keeps the two seal components in contact results from the inherent repulsive property of magnetic bodies having the same polarity.

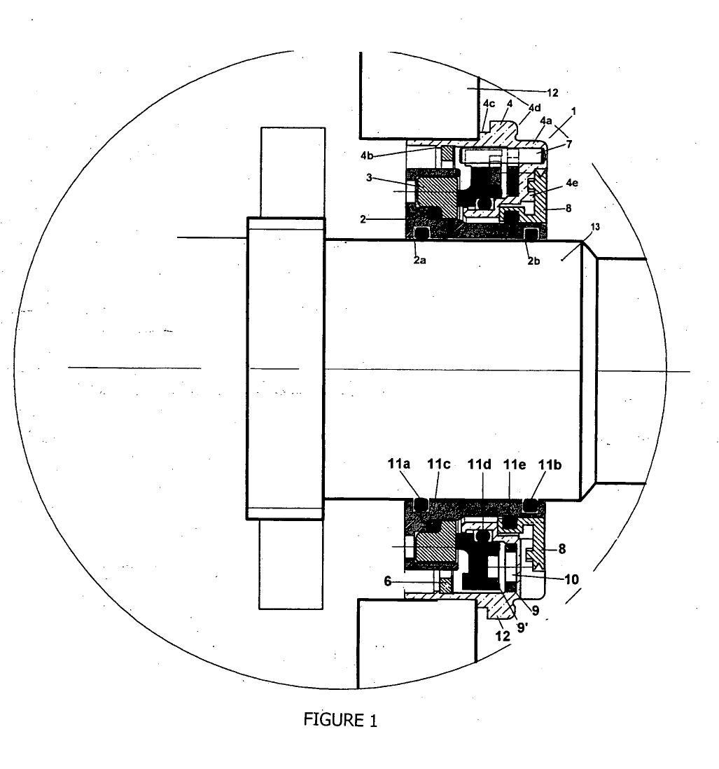

FIG. 1 shows a typical cross-section view of the schematic of the airtight magnetic seal (1) mounted on a shaft (13) and connected to a bearing casing (12). It can be seen in this Figure that some components are set in series on the bearing casing (12), while others, in another series, are set upon the shaft (13). Thus, the airtight magnetic seal (1) will operate with a series of components that travel along with the rotation of the shaft (13), while another series of components remains fixed on the bearing casing (12), and, therefore, static.

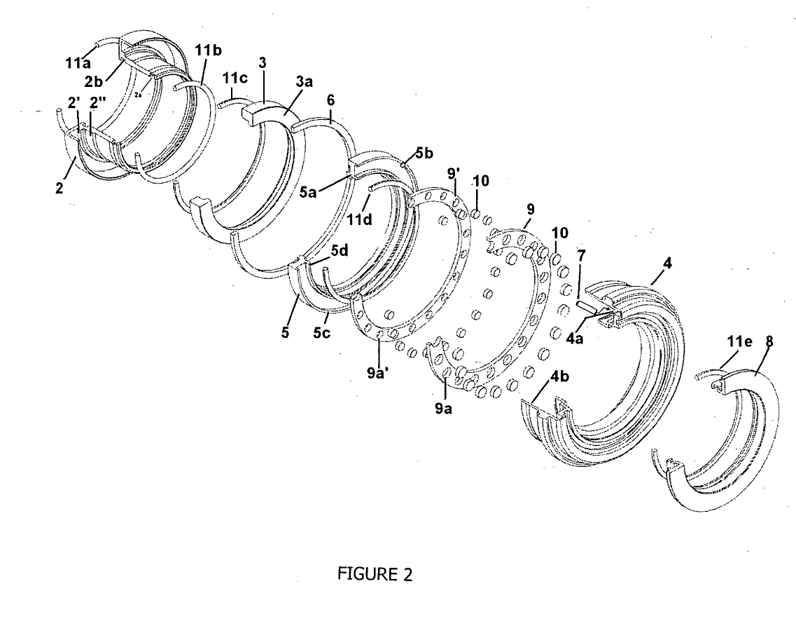

FIG. 2 shows a detailed and exploded view of a preferred prototype of the airtight magnetic seal (1). In this view each constitutive component may be identified on the airtight magnetic seal (1), shown in the order of mounting, said components basically included:

A) A circular sleeve (2) cut in the shape of a J, which fits into the shaft (13) not shown in this Figure.

B) A circular head (3) cut in the shape of an L, made of tungsten carbide, o, optionally, heat and/or chemically treated stainless steel, which is fixed on the sleeve (2).

In the opposite direction we have the following components, all connected in series to the bearing casing (12), which are:

C) A circular housing (4) that is cut in the shape of a J.

D) Two circular collars (9 and 9′), set in parallel and provided with several openings (9a and 9a′), with the diameter of (9a) greater than (9a′), where magnetic elements are fixed, such as magnets (10).

E) A primary circular seal (5), cut in the shape of an H, which is made up of carbon graphite impregnated with antimony or optionally impregnated with resin. The contact surface at the end of the longest leg of the “H” maintains permanent contact with the head (3), and the edges (5c and 5d) create a hollow with the rear surface, which extends around the entire circumference of the primary seal (5).

All of these components are linked together and to the bearing casing (12); consequently, they remain static in relation to the shaft.

F) A circular baffle (8), also L-shaped, with a V shaped slot around the entire greater diameter, and fixed upon the end of the sleeve (2), which is turned towards the outside of the bearing casing. In this way the baffle (8) travels along with the rotary movement of the first set of components listed above, that is to say, the sleeve (2) and the head (3).

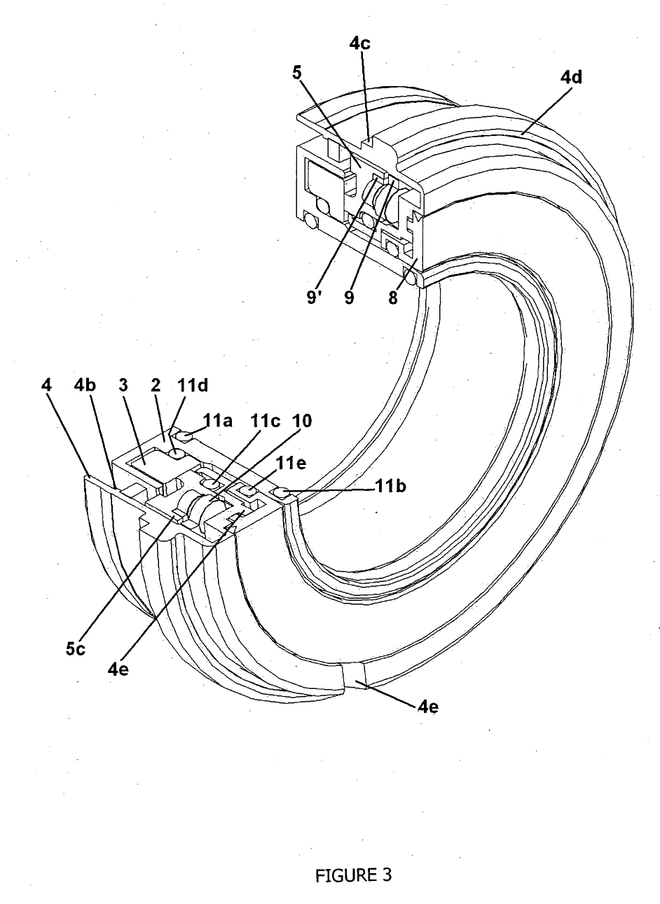

A detailed description of each component of the airtight magnetic seal (1) will be given, referring to FIGS. 1, 3, and 4, so that their functions may be well understood.

The internal wall of the sleeve (2) that faces the surface of the shaft (13) is provided with hollow areas (2a and 2b), to accommodate the seal O-rings (11e and 11b). The O-ring seals (11a and 11b) establish a seal between the internal surface of the sleeve (2) and the shaft (13). Since the O-ring seals (11a and 11b) are located at the ends of the sleeve (2), they are also responsible for the perfect axial alignment of the sleeve (2) to the shaft (13).

This construction arrangement facilitates and speeds up mounting of the airtight magnetic seal (1), as it dispenses with the use of special alignment tools and all the O-ring seals are made of fluoroelastomer rubber or similar material.

The attainment of a perfect alignment is fundamental to reducing wearing on the sealing elements, the head (3) and primary seal (5), that make up the airtight magnetic seal (1), since the head (3) is housed over the O-ring seal (11c), its auto-centering is facilitated.

The sleeve (2) is cut in the shape of a reclining J, which is distinguished by an extensive section that is parallel to the shaft (13), and other thick section that is perpendicular. The thick section is positioned towards the inside of the bearing casing (12), and has two levels: the higher level (2′) forms a hollow area that serves as support and housing to the next component, head (3), while the lower level (2″) may have a hollow area (2c), as shown in FIG. 1.

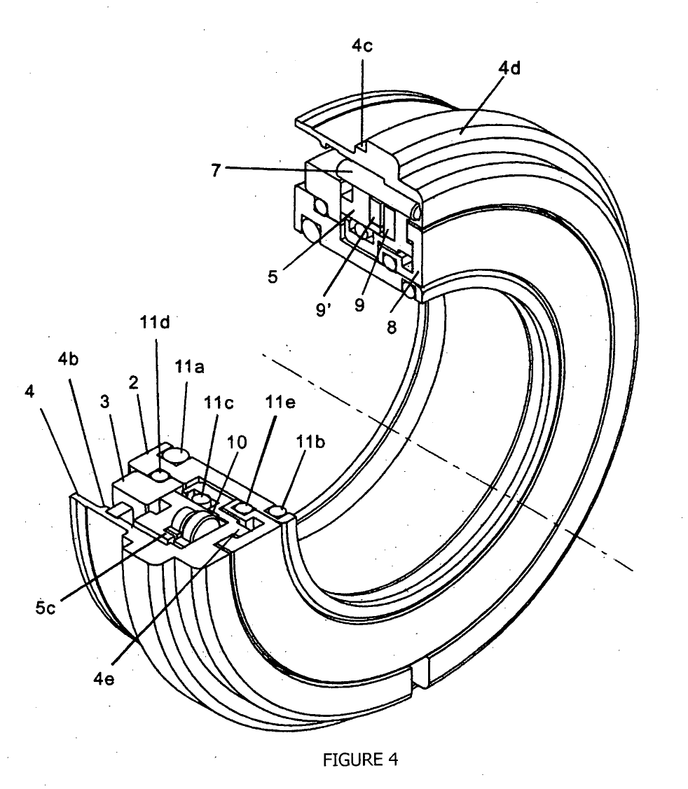

The head (3) is then positioned over the J-shaped sleeve (2), that alternatively may be provided in an L shape, in which case the head (3) does not remain enclosed on the sleeve (2), as shown in FIG. 4.

No matter which format is specified for the head (3), (which may also be rectangular); it is fixed (and may be removed) on the lowest level (2″) of the end of the sleeve (2), which is turned towards the inside of the bearing casing (12). The fixation is accomplished by the interference action of an O-ring seal (11c).

The O-ring seal (11c) is situated between the lower level (2″) of the sleeve (2) and the head (3), which may be, optionally, accommodated within a hollow area (2c) which is provided on the lowest level (2″) of the sleeve itself (2), as seen in FIG. 1.

Thus, axial dislocation of the head (3) is prevented towards the higher level (2′) of the end of the sleeve (2), which serves as support and cog, the radial movement of which is prevented by the O-ring seal (11c). This ring also establishes a seal between the head (3) and the sleeve (2).

In an alternative prototype, the head (3) may be wholly made of silicon, or may have the work surface (3a) lined with silicon.

With this configuration, the sleeve (2), as well as the head (3), travel along with the rotation of the shaft (13).

All the components of this first series are mounted upon the shaft (13) and work in association with the shaft, which forces them to be used first. A third component remains, the baffle (8), that is fixed to the sleeve (2), and also travels along with the rotation of the shaft (13); this is the last to be mounted, and will be described below.

Another series of components, which work in association with the bearing casing, are then mounted, and associated with the former components, the function of which promote impermeability of the airtight magnetic seal (1).

The series is basically made up of the housing (4), the primary seal (5) and the magnet (10) collars (9 and 9′), and is mounted in a juxtaposition and acts upon the first series of components described, promoting the impermeability of the airtight magnetic seal (1).

In a preferred construction possibility, the housing (4) is cut in a J shape, and is provided, on its internal surface, with at least one non-leaking opening (4a). This opening shall have a means of radial immobilization, for example, a pin (7), as shown in the current prototype, which is fixed and at the same time prevents the collars (9 and 9′), and the primary seal (5) from rotating. However, other means of fixation may be adopted to guarantee radial immobilization of these components.

On the inside of the housing (4) the collars (9 and 9′) are mounted in parallel to the respective magnets (10), fixed at their openings (9a and 9a′) in such a way that the surface of the magnets (10) are in a repulsive position.

The first collar (9) faces the inside of the housing (4), while the second collar (9′) is adjusted towards the internal surface of the primary seal (5), within the hollow area formed by the edges (5c and 5d). An O-ring seal (11d) adjusts itself between the inner side of the housing (4) and the side of the primary seal (5), and establishes the seal between the surfaces of these components. The O-ring seal (11d) works within an adjustment range of from 0.2 to 0.5 mm.

The pin (7) acts as a cog and prevents the rotation of the collars (9 and 9′) as well as the primary seal (5). The pin goes through a hole (5b) provided in the primary seal (5), as well as a hole in the collars (9a and 9′a) setting itself into the non-leaking opening (4a) of the housing (4). The whole set is kept inside the housing (4) by the action of an elastic steel ring (6). The elastic steel ring is maintained axially stable through a knurl (4b), on the inside of the housing (4).

The number of openings (9a and 9′a), and consequently of the magnets, provides the balance of necessary maximum and minimum pressure where the primary seal (5) must act upon the head (3). This value is the determining factor for maintaining a minimum and constant pressure between the primary seal (5) and the head (3). It is this pressure that defines the friction between the surfaces of the primary seal (5) and the head (3), and, consequently, the amount of heat generated as well as. The more wear originating from between these parts, determines the service life expectancy of these components and of the entire airtight magnetic seal (1).

In the construction configuration described, all the figures have magnets in a circular format, however magnets in different formats may be provided, for example, in a curved form or any other format.

There is the possibility of adopting an option constructed with collars (9 and 9′) devoid of openings (9a and 9′a), in which the collars themselves (9 and 9′) are entirely made up of material with magnetic properties, such as magnets.

The magnets (10) in the construction configuration presented should be made of Samarium Cobalt grade Sm2Co17 or Nickel Neodymium—grade 42 H. However, no matter what format or quantity of magnets used, the force of repulsion to be applied between the two collars (9 and 9′) must fall within in a range of between 0.3 Kgf to 3.7 Kgf.

With these pressure parameters applied between the head (3) and the primary seal (5), and with the natural friction between these components, the distance between the collars (9 and 9′) will increase until reaching a value in which the friction between the work surface (3a) and the contact surface (5a) will attenuate. In this way, these components work together to achieve a smooth and balanced system between friction, sealing, and work pressure, keeping the sealing system perfect and the level of wear tends to be minimal up until the end of the service life of the pump.

The housing (4) is fixed with a tight adjustment tolerance directly on the bearing casing (12). The housing fits through an opening in the bearing casing (12) until the shoulder (4c) leans against the external surface of the bearing casing (12). Exactly in this position, the contact surface (5a) of the primary seal (5) will exert the correct force against the work surface (3a) of the head (3), establishing the seal between the components that travel along with the rotation of the shaft (13) and those that remain static next to the bearing casing (12).

The axial positioning of the housing (4) is determined by the shoulder (4c), that, once pressed against the external surface of the bearing casing (12), finds its correct working position and alignment.

The exact axial position of the sleeve (2) on the shaft (13) needed to achieve the correct force against the contact surface (5a) on the head (3), is established through a means of inherent adjustment to the airtight magnetic seal itself (1), with no need to use proprietary tools or precise technique.

After mounting the sleeve (2) and the head (3) on the shaft (13), one may just tip this arrangement, the housing (4) into the inverted work position. The external surface of the housing (4) is opposite the head (3) and the sleeve (2) at the lower end of the “J” format and subsequently pushes against the entire arrangement until the shoulder of the alignment (4d) inclines the external surface of the bearing casing (12), in this way the calibration is performed. At this exact point the work surface (3a) of the head (3) and the sleeve, respectively, (2) are in the exact operating position and alignment. The housing (4) is again inverted turning to its work position and fits (with interference) through an opening in the bearing casing (12) until the shoulder (4c) leans against the external surface of the bearing casing (12).

Finalization of the mounting of the airtight magnetic seal (1) is obtained by nesting the baffle (8) into the outside end of the sleeve (2). Once nested, the baffle (8), (due to its L-shaped cut), overlaps part of the external surface of the housing (4).

The baffle (8) is fixed to the sleeve (2) through pressure exerted by an O-ring seal (11e), and consequently, travels along with the rotary motion of the shaft (13).

The free end of the baffle (8) forms a labyrinth with the external shoulder (4a) of the housing (4). The labyrinth thus formed, is complemented by the centrifugal action of the external wall of the rotating baffle (8), which adds up to a powerful protective barrier against any inclemency that might occur in the operational area at the contact surface (5a) on the head (3). This protection further preserves unaltered work conditions from the installation of the airtight magnetic seal (1) to the end of the pump's service life.

Due to low wear between the head (3) and the primary seal (5), increased even more by the protection offered by the baffle (8), the airtight magnetic seal (1), maintains a high preservation of all of its components until the end of the pump's service life. All that is needed is to change the seal rings, change the primary seal (5), grind down the head surface (3) and the seal may be applied again.

The dimensions of the seal are proportional and relative to the diameter of the shaft (13), and equipment shafts fall generally within a range of between 20 mm and 100 mm.

Thus the range of thickness applied to the airtight magnetic seal (1), may vary proportionally to the equipment shaft diameters. In shafts measuring between 20 mm and 79 mm, the thickness is between 15 mm and 18 mm; for seals applied on shafts between 80 mm and 100 mm, the thickness would be up to 20 mm.

These thicknesses are much smaller than that of seals currently known which use the repulsive force of magnets to establish the seal between the head and the primary seal. This new range of work thickness allows the application of the repulsive airtight magnetic seals in centrifugal pumps.

The invention has been described herein with reference made to its preferred final applications. However, it must be clarified that the invention is not limited to only these applications and those with technical abilities will immediately realize that alterations and substitutions may be made within the concept of this invention here described.

1. Airtight magnetic seal for bearing casings, including a sleeve, a head, a housing, a primary seal, a pair of collars magnets, O-ring seals, an elastic ring and a baffle, which are mounted to each other so as to form a seal for bearing casings, wherein the sealing elements are kept in permanent contact due to the force emanating form the repulsive property inherent in magnetic bodies having the same polarity, that is applied upon said sealing elements,
wherein said sleeve is a circular sleeve and cut in the shape of a J which is inclined in relation to the shaft, with an extensive section and parallel to the shaft, and another section which is thick and perpendicular to said shaft, with the thick section upon the shaft turned towards the inside of the bearing casing with two levels, a higher level and another level which is lower, where, within the unequal section between the higher level and the other, a sealing ring fits and on this a circular head cut in the shape of an L with one side being thicker than the other; the thicker side of the heads is lodged upon the higher level of the sleeve and the thinner side of the head is lodged upon the lower level; to be the surface perpendicular to the sleeve, its thicker side, which is made to turn towards the bearing casing, is perforated with between 3 and 8 equidistant openings; to be the internal wall of said sleeve that faces the shaft's surface provided with hollow areas on its ends, said hollow areas accommodate, respectively, O-ring seals;
wherein said housing is a circular housing that is cut in the shape of a J, and its inner surface supports the first of said collars; wherein the circular primary seal is cut in the shape of an H, being mounted with its contact surface juxtaposed to the work surface of the head; a second of said collars is provided, nested in a hollow area formed by the edges of the back surface of said primary seal, adjacent and parallel to the first collar, but without inclining upon it; the collars are provided with perforations where as many magnets that are necessary shall be fixed, with said primary seal, the collars, the magnets have the having their rotary movement impeded by at least one set pin fixed on the housing; to adjust a sealing ring between the internal side of said housings and the side of said primary seal; the housing has a groove for drainage and is nested in an opening in the bearing casing, with a tight adjustment tolerance, until its shoulder leans against the external surface of the bearing casing;
wherein the baffle is a circular baffle that is cut in the shape of an L, and fitted to the external end of said sleeve, kept fixed in this position by the pressure exerted by an O-ring seal, being that the baffle overlaps part of the external surface of the housing, and its free end forms a labyrinth with the external shoulder of the housing; the greater diameter of the baffle contains a circular groove in the form of a V.

2. Airtight magnetic seal for bearing casings in accordance with claim 1, wherein the circular head is cut in a rectangular shape.

3. Airtight magnetic seal for bearing casings in accordance with claim 1, wherein the circular head is cut in an L shape.

4. Airtight magnetic seal for bearing casings in accordance with claim 2, wherein the lower level of the sleeve is provided with a hollow area.

5. Airtight magnetic seal for bearing casings in accordance with claim 2, wherein the head is made of thermally or chemically treated stainless steel.

6. Airtight magnetic seal for bearing casings in accordance with claim 2, wherein the head is to be made of tungsten carbide or a tungsten compound.

7. Airtight magnetic seal for bearing casings in accordance with claim 2, wherein the head is to be made of silicon or lined with a silicon layer.

8. Airtight magnetic seal for bearing casings in accordance with claim 1, wherein the primary seal to be made of graphite, and optionally, charcoal impregnated with resin or antimony.

9. Airtight magnetic seal for bearing casings in accordance with claim 1, wherein the collars have openings where magnets having different diameters are fixed respectively.

10. Airtight magnetic seal for bearing casings in accordance with claim 9, wherein the collars have perforations in a curved form where magnets are fixed, respectively, also in a curved format.

11. Airtight magnetic seal for bearing casings in accordance with claim 1, wherein the collars are made of materials with magnetic properties.

12. Airtight magnetic seal for bearing casings in accordance with claim 9, wherein the magnets are selected preferably from Nickel Neodymium and Nickel plated Samarium Cobalt.

13. Airtight magnetic seal for bearing casings in accordance with claim 9, wherein the force of repulsion applied between the two collars is within the range of 0.3 Kgfa and 3.7 Kgf.

14. Airtight magnetic seal for bearing casings in accordance with claim 1, wherein the applied thickness of the airtight magnetic seal varies proportionally to the diameter of the equipment shafts, for shafts within a range of 20 mm and 79 mm in diameter, the total thickness of the airtight magnetic seal falls within a range of between 15 mm and 18 mm and for shafts measuring between 80 mm and 100 mm, the thickness ranges from 19 mm and 20 mm.

15. Airtight magnetic seal for bearing casings in accordance with claim 1, wherein the correct operational axial positioning of the sleeve on the shaft to be is calibrated, pressing said housing in an inverted position against the head until the shoulder inclines on the external surface of the bearing casing.
